(19) United States
(12) Patent Application Publication
(10) Pub. No.: US 2010/0236291 A1
(43) Pub. Date: Sep. 23, 2010

(54) ARTICLES MADE FROM CO-POLYMER BASED POLYIMIDE AND THEIR USES IN HIGH TEMPERATURE APPLICATIONS

(75) Inventors: John P. Cunningham, Avondale, PA (US); Jeffrey L. Loudin, Landenburg, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmintong, DE (US)

(21) Appl. No.: 12/724,810

(22) Filed: Mar. 16, 2010

Related U.S. Application Data
(60) Provisional application No. 61/160,941, filed on Mar. 17, 2009.

(51) Int. Cl. C08G 73/10; B29C 43/00; C03B 7/00

(52) U.S. Cl. 65/137; 264/331.19; 521/185; 65/165

(57) ABSTRACT

Disclosed herein is a method for making polyimide articles that are suitable for high temperature applications. The articles disclosed herein are rigid, oxidatively stable, wear-resistant, and permeable to heated moisture and gases, and comprise co-polymer based polyimide, and at least one additive or filler, and are made using 20,000 to 50,000 psi of compression pressure.

### CROSS REFERENCE TO RELATED APPLICATIONS

This application claims the benefit of priority to U.S. Provisional Application No. 61/160,941, filed Mar. 17, 2009.

### FIELD OF THE INVENTION

Plastic materials have broad industrial applications, including some high temperature applications. Polyimides can be used for some higher temperature applications, but may also need to possess certain other physical properties. Disclosed herein are copolymer-based polyimide articles having increased permeability, wear resistance, durability, oxidative stability, desirable wear life and resistance to defect upon thermal exposure.

### BACKGROUND OF THE INVENTION

High temperature operating conditions and industrial manufacturing require the use of materials that are tolerant of the conditions. Presently, as in the past, metal, ceramic, graphite, asbestos and other materials have been used for high temperature applications. Plastics have been useful in replacing some of these materials for high temperature applications. However, some applications also require materials that have additional properties, such as, for example, wear-resistance, chemical resistance, low-friction, decreased wear, and other properties that afford compatibility for its application.

Glass, and more particularly glass containers including glass bottles, are manufactured using molten glass at temperatures in the range of from about 1400° C. to 1600° C. During manufacturing, freshly formed glass containers and glass bottles maintain high temperatures for a time, and are slowly cooled to avoid creating defects in the containers upon cooling the glass. While at these high temperatures, parts are used to mechanically handle or stabilize, lift, convey, move, transport, sweep, stack or otherwise contact the hot, freshly made glass containers. A mechanical part in contact with semi-molten or recently formed hot glass or hot glass container can be heated as a consequence to exposure to the high temperature of the glass container. Accordingly, a mechanical part used for handling hot glass needs to be oxidatively stable.

When heated by the semi-molten glass or freshly or recently formed hot glass containers, any moisture in the mechanical part is also heated whereby heated moisture and gases can be trapped within the pores of the part as the part cools. As the cross-section of the mechanical part increases, the surface area of the part is less accessible to the trapped heated moisture and gas, constraining their release. In such cases, the mechanical part is vulnerable to defects, such as blistering, due to the rapid thermal cycling. A progressive reduction in a part's mechanical properties can also occur with repeated cycles of moisture exposure and thermal exposure, evidenced by a reduction in measured glass transition temperature (tg) of plastics, sometimes referred to as “wet Tg knockdown”.

Assemblies and components consisting essentially of graphite have been used in hot glass handling applications, as disclosed in U.S. Pat. RE 34,953. Although useful for high temperature applications, graphite is brittle and therefore lacks durability, cannot sustain the load applied in some applications, and lacks the wear life desired by for many applications.

Other materials made from plastics have been used, such as thermoset materials. However, many of these materials are not suitable for high temperature applications, lack strength, durability and the desired mechanical properties, leading to faster degradation over graphite. See U.S. Pat. No. 7,418,834 B2, issued Sep. 2, 2008, which discloses that plastics suitable for use at the high temperatures encountered in the hot end process area must be specially formulated and also have a relatively short service life.

Polyimide materials have also been used in hot glass handling applications. For example, Cerberite, commercially available from Carbone of America, in St. Marys, Pa. has been indicated for such use. However, it is only recommended for temperatures up to 275° C., rendering it unsuitable for higher temperature applications, such as mechanically handling hot glass in glass container manufacturing. This is well below the operating temperature needed for applications run at 400° C. and higher.

The object of the present invention is to provide a method for making an article prepared from a polyimide composition wherein the article is suitable for high temperature applications, having rigidity, oxidative stability, permeability to heated moisture and gases to avoid defects caused by rapid thermal cycling, or thermal exposure.

Furthermore, the polyimide parts made by the method of the present invention are not susceptible to the build up of degraded oil residue, as is the case with graphite-based materials used in the same or similar applications.

### BRIEF DESCRIPTION OF THE DRAWINGS

FIG. 1 is a graphical representation of the tensile strength vs. compaction pressure for an article comprising copolymer-based polyimide made according the present disclosure.

FIG. 2 is a graphical representation of elongation vs. compaction pressure for an article comprising copolymer-based polyimide made according the present disclosure.

FIG. 3 is a rectangular blank design from which a take-out insert for hot glass handling articles can be machined.

FIG. 4 is glass bottle manufacturing take-out insert design. The take-out insert is a consumable components used in manufacturing glass bottles. The insert is used to move the hot glass from a mold to a conveying system.

FIG. 5 is an equipment bearing. In a glass container manufacturing operation this article illustrates part of a conveying system. Typically, a bearing is located on the rotating component of a Lehr conveyor.

FIG. 6 is a triangular insulator pad. In glass container manufacturing a Lehr stacker bar moves glass bottles from a conveyor line into a tempering oven. Insulator pads prevent hot glass from touching thermal conductive metal parts of the conveyor system where checking can occur.

FIG. 7 is a circular blank design for hot glass manufacturing assembly component, which is a common industry insert design for machining take-out components.

FIG. 8 is a rectangular insulator pad, which can be utilized in conjunction with a Lehr push bar to convey glass from one conveyor system to another, or in other hot insulating areas of the conveying systems.

FIG. 9 is a sweep-out pad or bar, which is used to move hot glass while insulating to prevent checking as hot glass or a hot glass container is transferred from one conveyor system to another.

### SUMMARY OF THE INVENTION

Disclosed herein is a method of making an article for high temperature applications, said article comprising a co-polymer based polyimide composition, wherein said composition comprises
a) an aromatic tetracarboxylic dianhydride component; and
b) a diamine component further comprising;
   (i) greater than 60 mole % to about 85 mole % p-phenylene diamine, and
   (ii) 15 mole % to less than 40 mole % m-phenylene diamine;
wherein a) and b) are present in a ratio of 1:1; and
   said method comprising:
forming a part of pre-determined shape using compression;
   wherein the amount of pressure used in compression is from about 20,000 psi to about 50,000 psi to achieve a porous article having permeability to moisture, and resistance to defect caused by thermal exposure.

Also disclosed herein is an article of manufacture for use in a high temperature applications, said article comprising a co-polymer based polyimide composition, wherein said composition comprises
a) an aromatic tetracarboxylic dianhydride component; and
b) a diamine component further comprising;
   i) greater than 60 mole % to about 85 mole % p-phenylene diamine, and
   ii) 15 mole % to less than 40 mole % m-phenylene diamine;
wherein a) and b) are present in a ratio of 1:1; and
   said article being porous and having permeability to moisture, and resistant to defect caused by thermal exposure.

### DETAILED DESCRIPTION OF THE INVENTION

The present invention provides a method for making an article suitable for use in high temperature applications. The article made according the method of the present invention is an article wherein such article is durable, wear resistant over time in high temperature applications, rigid, oxidatively stable, and resistant to defect caused by rapid thermal cycling.

In the present method, the article comprises a co-polymer based polyimide composition,

wherein said composition comprises
a) an aromatic tetracarboxylic dianhydride component; and
b) a diamine component further comprising;
   i) greater than 60 mole % to about 85 mole % p-phenylene diamine, and
   ii) 15 mole % to less than 40 mole % m-phenylene diamine;
wherein a) and b) are present in a ratio of 1:1; and said method comprising:
forming a part of pre-determined shape using compression;
   wherein the amount of pressure used in compression is from about 20,000 psi to about 50,000 psi to achieve a porous article having permeability to moisture, and resistance to defect caused by thermal exposure.

In one embodiment of the present invention the compression pressure may be pre-determined to make an article having a certain desired density.

In one embodiment of the method in the present invention, the article may have a higher cross-section relative to the surface area of the article, and said article and is capable of releasing moisture and gas present in the cross-section of the article through the surface area of the article.

In yet another embodiment of the method disclosed herein, the polyimide composition may comprise at least one filler. The fillers used in the present invention are carbonaceous filler selected from the group consisting of natural graphite, synthetic graphite and carbon fiber; fluoropolymer, including but not limited to polytetrafluoroethylene, and inorganic fillers selected from the group consisting of kaolinite, sepiolite and mixtures thereof.

The article made by the method of the present invention is useful in glass manufacturing, especially glass handling during steps that require contact of the article with hot glass, such as mechanical handling, conveying, moving, lifting, transporting, etc. One example of such use is a take-out jaw insert or a take-out jaw assembly.

The present invention is useful for many other applications, especially high temperature applications. The articles made as disclosed herein can be used to replace conventional materials used in high temperatures. For example, the articles made as disclosed herein can be used to replace mechanical elements, parts that are mainly composed of graphite, metal, ceramic, or asbestos. Particular uses of the articles made as disclosed herein include use in glass manufacturing or glass container manufacturing. More specifically, a use of the method and articles disclosed herein is in the use of manufacturing glass bottles. The embodiments of the method and the articles disclosed are used to mechanically handle hot glass during the manufacture of glass containers, such as glass bottles.

Other uses of the articles of the present invention are as parts in a convection oven, scientific instrumentation, such as to isolate defracting chambers, in automotive systems, including as an emission system part, internal combustion engine parts, bushing, bearing, washer, seal ring, wear pad and slide block. Additional uses of the parts disclosed herein are selected from the group consisting of a recycle system; a clutch system; a pump; a turbocharger; a thrust reverser, nacelle, a flaps system; an injection molding machine; conveyor; and tenter frame.

A further disclosure of the present invention is the use of an article made by the method disclosed herein in high temperature applications, and more particularly in glass manufacturing, and more particularly glass container manufacturing.

The present invention provides a method for making formed parts from a polyimide composition, wherein the part has improved oxidative stability and excellent tensile properties. Such formed parts are useful in high temperature applications, or applications operating at or above about 400° C. In addition to glass container manufacturing, other uses of the articles made by the method of the present invention include scientific instrumentation, convection ovens, heated conveyors, automotive applications and aerospace engines. More particularly, parts and other articles prepared using the method of the present invention include, but are not limited to, aircraft engine parts such as bushings, bearings, washers, seal rings, gaskets, wear pads and slide blocks. These parts may be used in all types of aircraft engines such as reciprocating piston engines and, particularly, jet engines. Parts and other articles prepared using the method of the present invention are also useful in the following: automotive and other types of internal combustion engines; other vehicular subsystems such as exhaust gas recycle systems and clutch systems; pumps; non-aircraft jet engines; turbochargers; aircraft subsystems such as thrust reversers, nacelles, flaps systems and valves; materials processing equipment such as injection molding machines; material handling equipment such as conveyors, belt presses and tenter frames; and films, seals, washers, bearings, bushings, gaskets, wear pads, seal rings, slide blocks and push pins and other applications where low wear is desirable. In some applications, a part or other article prepared according to the method disclosed herein is in contact with metal at least part of the time when the apparatus in which it resides is assembled and in normal use.

By the term “rigid polyimide” is meant is that there are no flexible linkages in the polyimide unit.

By the term “handling” is meant mechanical handling, including stabilizing, lifting, conveying, moving, transporting, sweeping, stacking or contacting.

The aromatic tetracarboxylic dianhydride components used to make the copolymer polyimide of the present invention include pyromellitic dianhydride (PMDA), 3,3′4,4′-biphenyltetracarboxylic dianhydride (BPDA), and any other rigid aromatic dianhydride. Best results occur when BPDA is used as the dianhydride component. For a preferred embodiment of the present invention, the solution imidization process is used to provide a rigid, aromatic polyimide composition having the recurring unit

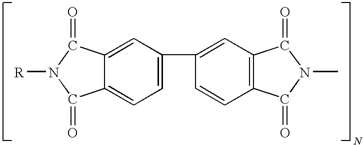

where R is greater than 60 to 85 mole % PPD units and 15 to less than 40 mole % MPD units. Polyimide compositions having 70% PPD and 30% MPD are preferred.

In the preparation of the present polyimide compositions, the solution imidization process is utilized according to the following. The diamines (PPD and MPD) are generally first dissolved in a solvent to form the diamine component. In general, after dissolving the diamine component in the required concentration of the solvent, the dianhydride is added to the reaction solution in substantially equimolar quantities to form a polyamide acid (PAA) polymer solution. A slight molar excess of either the dianhydride or diamine component is possible. A molar excess of 0.5 to 1.0% of the diamine component has been found to provide best results. As a general rule, better tensile properties result from closer to equimolar stoichiometry but this must be balanced against the higher viscosity that occurs as the equimolar point is approached as would be known by one of ordinary skill in the art.

The resulting PAA polymer solution is transferred over a period of time to a heated solution of the solvent. The transferred PAA polymer solution is continuously heated and agitated to complete the reaction of soluble PAA to a slurry of insoluble polyimide.

The resulting polyimide slurry is washed with solvent and dried at 100 to 230° C., preferably 140 to 190° C., more preferably 180° C., to convert the polyimide slurry to a polyimide resin in the form of a powder having a high surface area. The optimum temperature of 180° C. results in greater process efficiency and better physical properties. Depending on the particle size resulting from the precipitation of polyamide acid from the reaction solution, the particles of polyimide can be further modified for example, by suitable grinding techniques, to provide a desirable particle size for handling and subsequent molding.

The solvents useful in the solution polymerization process for synthesizing the PAA polymer solution are the organic solvents whose functional groups will not react with either of the reactants (the BPDA or the diamines) to any appreciable extent. The solvent exhibits a pH of about 8 to 10, which can be measured by mixing the solvent with a small amount of water and then measuring with pH paper or probe. Such solvents include, for example, pyridine and β-picoline. Of the solvents disclosed in Gall and U.S. Pat. No. 3,179,614 to Edwards, pyridine (KB=1.4×10-9) is a preferred solvent for these reactants in the polymerization reaction as well as functioning as the catalyst. For a dianhydride and a diamine to react to form a PAA polymer solution, a basic catalyst is needed. Since pyridine is a basic compound, it functions herein as both a catalyst and a solvent.

The quantity of solvent is important in obtaining a product having a high surface area. In particular, the solvent should be present in a quantity such that the concentration of the PAA polymer solution is about 1 to 15% by weight solids, preferably from about 8 to 12% by weight solids.

The surface area for a polyimide resin resulting from the polyimide composition of this invention should be at least 20 m2/g. It is preferable that the surface area be at least 75 m2/g to achieve acceptable physical properties and for ease of processability.

In the preparation of the PAA, it is essential that the molecular weight be such that the inherent viscosity (IV) of the PAA polymer solution is at least 0.2 dl/g, preferably 0.5 to 2.0 dl/g. The method for measuring and calculating IV is described below.

The polyimide composition often comprises at least one filler or one type of filler. The filler in the polyimide composition of the present invention filler may include clays, such as kaolinite or sepiolite; fluoropolymer or copolymer, such as polytetrafluoroethylene; molybdenum disulfide; and/or carbonaceous fillers such as graphite, carbon fiber. The fillers can be used to improve wear and frictional characteristics while retaining the excellent tensile and oxidative stability of the polyimide composition and parts made therefrom.

Graphite as suitable for use herein can be either naturally occurring graphite or synthetic graphite. Natural graphite generally has a wide range of impurity concentrations, while synthetically produced graphite is commercially available having low concentrations of reactive impurities. Graphite containing an unacceptably high concentration of impurities can be purified by any of a variety of known treatments including, for example, chemical treatment with a mineral acid. Treatment of impure graphite with sulfuric, nitric or hydrochloric acid, for example, at elevated or reflux temperatures can be used to reduce impurities to a desired level.

A sepiolite filler, a kaolin filler, or a mixture thereof is also suitable for use herein. A sepiolite filler suitable for use herein includes sepiolite itself [Mg₄Si₆O₁₅(OH)₂.6(H₂O)], which is a hydrated magnesium silicate filler that exhibits a high aspect ratio due to its fibrous structure. Unique among the silicates, sepiolite is composed of long lath-like crystallites in which the silica chains run parallel to the axis of the fiber. The material has been shown to consist of two forms, an α and a β form. The α form is known to be long bundles of fibers and the form is present as amorphous aggregates.

A sepiolite filler suitable for use herein also includes attapulgite (also known as palygorskite), which is almost structurally and chemically identical to sepiolite except that attapulgite has a slightly smaller unit cell.

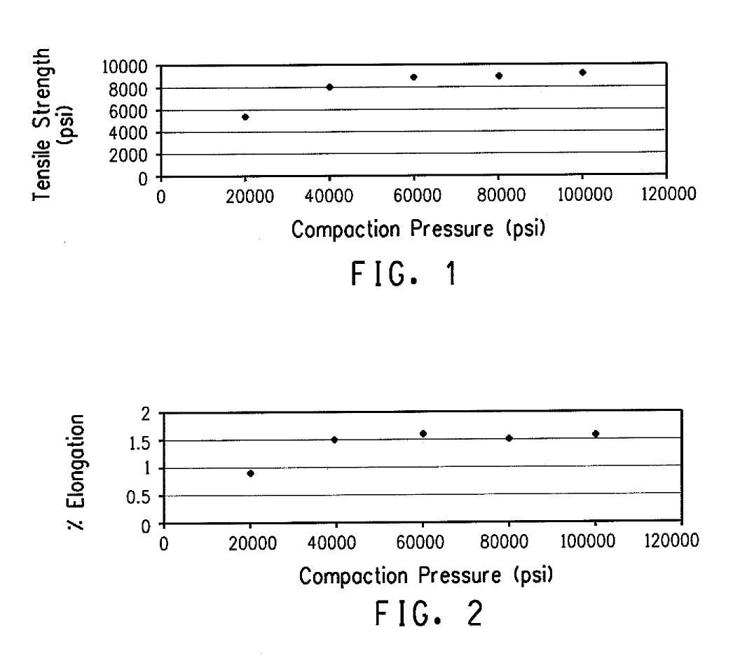

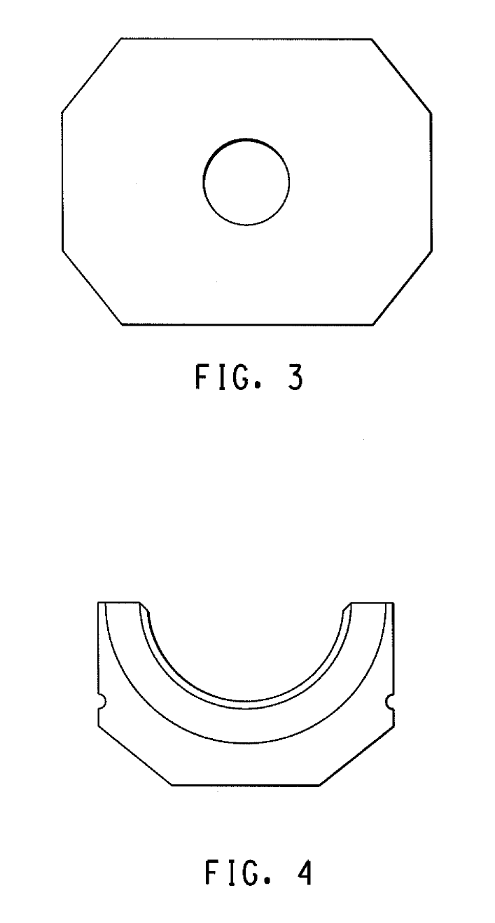

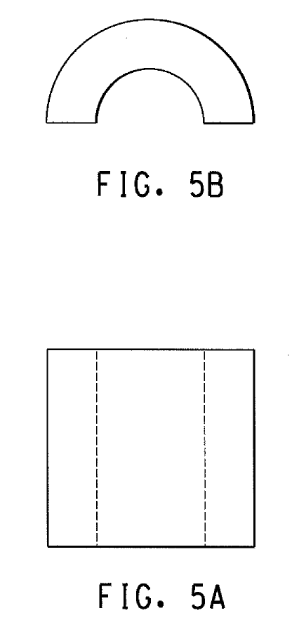

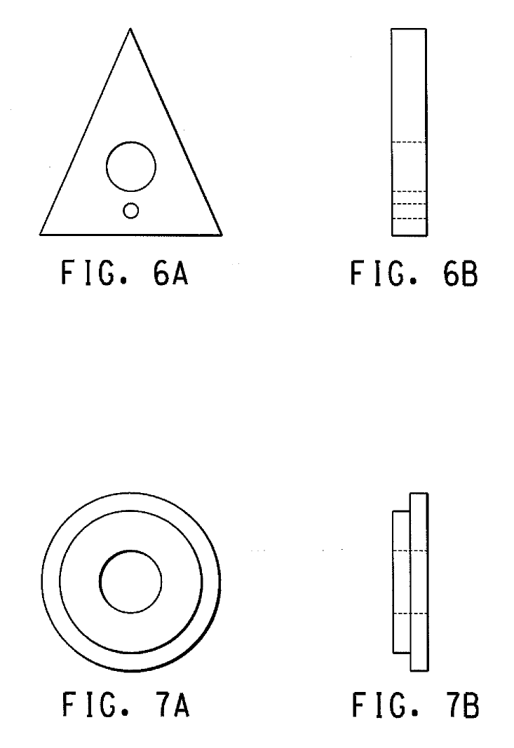

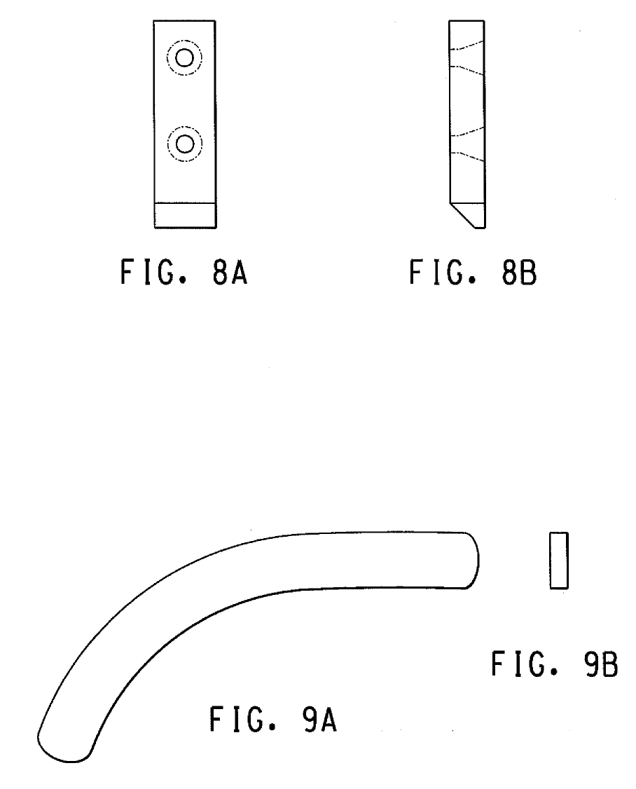

A sepiolite filler suitable for use herein also includes clays that are layered fibrous materials in which each layer is made up of two sheets of tetrahedral silica units bonded to a central sheet of octahedral units containing magnesium ions [see, e.g., FIGS. 1 and 2 in L. Bokobza et al, Polymer International, 53, 1060-1065 (2004)]. The fibers stick together to form fiber bundles, which in turn can form agglomerates. These agglomerates can be broken apart by industrial processes such as micronization or chemical modification (see, e.g., European Patent 170,299 to Tolsa S.A.).

In one embodiment, a sepiolite filler suitable for use herein includes a rheological grade sepiolite clay, such as that which is described in EP-A-454,222 and/or EP-A-170,299 and marketed under the Pangel® trademark by Tolsa S.A., Madrid, Spain. The term “rheological grade” in this context refers to a sepiolite clay typically having an average surface area greater than 120 m²/g [as measured in N₂ by the Brunauer/Emmett/Teller method (as described in Brunauer et al, “Adsorption of Gases in Multimolecular Layers”, Journal of the American Chemical Society, 60: 309-19, 1938)], and typically having average fiber dimensions of about 200 to 2000 nm long, 10-30 nm wide, and 5-10 nm thick. Rheological grade sepiolite is obtained from natural sepiolite by means of micronization processes that substantially prevent breakage of the sepiolite fibers, such that the sepiolite disperses easily in water and other polar liquids, and has an external surface with a high degree of irregularity, a high specific surface, greater than 300 m²/g and a high density of active centers for adsorption, that provide it a very high water retaining capacity upon being capable of forming, with relative ease, hydrogen bridges with the active centers. The microfibrous nature of the rheological grade sepiolite particles makes sepiolite a material with high porosity and low apparent density.

Additionally, rheological grade sepiolite has a very low cationic exchange capacity (10-20 meq/100 g) and the interaction with electrolytes is very weak, which in turn causes rheological grade sepiolite to not be practically affected by the presence of salts in the medium in which it is found, and therefore, it remains stable in a broad pH range. The above-mentioned qualities of rheological grade sepiolite can also be found in rheological grade attapulgite, which typically has a particle size smaller than 40 microns, such as the range of ATTAGEL® clays (for example ATTAGEL 40 and ATTAGEL 50) manufactured and marketed by Engelhard Corporation, United States; and the MIN-U-GEL range of products from Floridin Company.

A kaolin filler suitable for use herein includes kaolinite itself, which is a sheet-type silicate whose molecules are arranged in two sheets or plates, one of silica and one of alumina. Kaolinite is a clay mineral with the chemical composition Al₂Si₂O₅(OH)₄. It is a layered silicate mineral, with one tetrahedral sheet linked through oxygen atoms to one octahedral sheet of alumina octahedra. Rocks that are rich in kaolinite are known as china clay or kaolin. In contrast, smectites such as montmorillonite clay minerals are arranged in two silica sheets and one alumina sheet. The molecules of the smectites are less firmly linked together than those of the kaolinite group and are thus further apart. Maintaining the phase stability of crystal structure of the sheet silicates is desirable, as is maintaining the thermal stability of the structural water of the sheet silicates at higher temperatures, such as up to about 450° C. [as shown, for example, by thermogravimetric analysis (TGA)]. Loss of structural water during processing of a polyimide composition can result in harm to polyimide integrity, and possibly change the crystal structure of the sheet silicate, giving a harder, more abrasive compound. Examples of sheet silicates that are not stable enough to be included in the compositions described herein are montmorillonite, vermiculite, and pyrophyllite. Kaolin fillers suitable for use herein are discussed further in Murray, Applied Clay Science 17 (2000) 207-221.

Sepiolite fillers and kaolin fillers that are suitable for use herein are discussed further in Murray, Applied Clay Science 17 (2000) 207-221.

Use of graphite, sepiolite and/or kaolin as filler, in the embodiments of the present invention are typically incorporated into the heated solvent prior to transfer of the PAA polymer solution (or other solution for other types of monomers), so that the resulting polyimide is precipitated in the presence of the components (b) and (c), which thereby become incorporated into the composition.

Additives suitable for optional use in a composition hereof may include, without limitation, one or more of the following: pigments; antioxidants; materials to impart a lowered coefficient of thermal expansion, e.g. carbon fibers; materials to impart high strength properties e.g. glass fibers, ceramic fibers, boron fibers, glass beads, whiskers, graphite whiskers or diamond powders; materials to impart heat dissipation or heat resistance properties, e.g. aramid fibers, metal fibers, ceramic fibers, whiskers, silica, silicon carbide, silicon oxide, alumina, magnesium powder or titanium powder; materials to impart corona resistance, e.g. natural mica, synthetic mica or alumina; materials to impart electric conductivity, e.g. carbon black, silver powder, copper powder, aluminum powder or nickel powder; materials to further reduce wear or coefficient of friction, e.g. boron nitride or poly(tetrafluoroethylene) homopolymer and copolymers. Fillers may be added as dry powders to the final resin prior to parts fabrication.

Any one or combination of additives and/or fillers can be present in quantities ranging from 0.1 to 80 wt. %. The particular filler or fillers selected, as well as the quantities used, will, of course, depend on the effect desired in the final composition, as will be evident to those skilled in the art.

These additives or fillers are typically, but not always incorporated into the heated solvent prior to transfer of the PAA polymer solution so that the polyimide is precipitated in the presence of the filler which is thereby incorporated. In some cases, the filler(s) or additive(s), or both, is dry blended with the polyimide particulate. The form of the fillers will depend on the function of the filler in the final products. For example, the fillers can be in particulate or fibrous form.

As stated previously, the polyimide compositions of the present invention are oxidatively stable. To test oxidative stability, tensile bars are formed as described below and then subjected to extreme temperatures for a fixed, lengthy period of time. The tensile bars are weighed both before and after testing and percent weight loss is calculated. The rigid, aromatic polyimide compositions of the present invention are considered to be oxidatively stable if the percent weight loss is less than 5%, preferably less than 3%, because such a weight loss would not compromise the integrity of the tensile bar, or more specifically, parts made by the method of the present invention as disclosed herein.

The polyimide articles of the present invention are characterized not only by the excellent thermal oxidative stability alone, or any one property alone, but by the exceptional tensile properties, together with other properties that are not insignificant in high temperature applications, such as durability, wear resistance and wear life, rigidity, permeability to heated moisture and gas, and resistance to defect upon thermal exposure. Both tensile strength and elongation are particularly important properties for applications as described above. As is generally known to those of ordinary skill in the art, products having low elongation tend to be brittle which leads to cracking during machining or in load bearing applications.

The polyimide composition made as disclosed herein can be molded under elevated pressures to a wide variety of configurations. For many applications, the polyimide composition is molded at pressures of about from 50,000 to 100,000 psi (345 to 690 MPa) at ambient temperatures.

The method of making the articles for high temperature applications, including the permeability of heated moisture and gases is a direct forming method, and is carried out by introducing the polyimide composition to a mold, sintering the polyimide composition at elevated temperatures of from about 300° C. to about 450° C. while compressing the part using from about 20,000 psi to about 50,000 psi, preferably from about 35,000 psi to about 45,000 psi, and most preferably about 40,000 psi of pressure to form a the article or part.

The articles or parts made by compressing the polyimide composition at from about 20,000 psi to about 50,000 psi are useful in high temperature applications. More particularly, the articles of parts made by the method of the present invention are useful in glass manufacturing, and more particularly glass container manufacturing. Such articles or parts include, but are not limited to glass handling assemblies, and components thereof. These include take-out jaw assemblies and components thereof, including take-out jaw inserts, dead plates, sweep out devices, stacker bars, stacker bar pads, stacker bar bearings, and components of any of these.

Polyimide materials readily absorb atmospheric moisture. Depending on the environment, the equilibrium point may be greater than 1% by weight. As a polyimide material is heated, this moisture will evolve. However, if the material is heated at a faster rate than this moisture can escape, blistering may occur. This phenomenon can limit the use of the polyimide material in many applications. In order to overcome this limitation, we have investigated ways to increase the permeability of the polyimide material. We have demonstrated that compacting or compressing of the polyimide material at lower pressures can result in a more porous structure with significantly better resistance to blistering during thermal exposure, or during exposure to rapid thermal cycling. We have also demonstrated that this can be done without significantly affecting the mechanical properties of the material which is key to its high temperature wear performance and durability.

The co-polymer based polyimide used in the method(s) and in the article(s) of the present invention imparts certain advantages in high temperature applications such as hot glass handling applications, aircraft engines and parts, or analytical scientific instruments, over the use of traditional and commonly used polyimide materials, and carbon graphite materials (for example, free of polyimide).

The methods and uses disclosed herein provide low thermal conductivity, demonstrating approximately 50 to 100 times lower heat transfer coefficient versus articles prepared using traditional carbon graphite. Lower thermal conductivity of the articles of the present invention, and related use of the articles of the present invention, impart minimization or elimination of blisters, checks, and micro-cracks, thereby lowering quality rejects and improving productivity.

It is also found that the method articles of the present invention provider high impact resistance at 70 to 100% higher than carbon graphite parts that are traditionally used in hot glass manufacturing applications. Reduced breakage of the articles during fabrication, handling and use extends the life of the articles, which then increases process reliability and reduces operating costs.

Oil absorption is also observed in the methods and articles of the present invention. The components made in the present invention absorb 30 times less oil than carbon graphite parts to zero oil absorption. Reduced or eliminated oil absorption affords the advantage of reduced checking in the containers handled by the articles, thus an increased yield of the containers, and reduction reduced operating costs.

Another advantage of the method and articles of the present invention is reduced wear. Test results show three times less wear versus carbon graphite at 600 degrees F. (315 degrees C.) in oscillatory conditions, demonstrating 2 to 11 times longer life over glass handling carbon graphite take-out inserts. Such an advantage translates into significantly longer life of consumables to increase production efficiency.

### EXAMPLES

| Com- | | | | | |
|---|---|---|---|---|---|
| paction | Tensile | % | | | |
| Pressure | Strength | Elonga- | Specific | | Blistering |
| (psi) | (psi) | tion | Gravity | TOS | Temperature |
| 20000 | 5323 | 0.9 | 1.551 | 3.46% | Pass at 400° C. |
| 40000 | 8096 | 1.5 | 1.632 | 3.09% | Pass at 400° C. |
| 60000 | 8858 | 1.6 | 1.665 | 2.19% | Fail at 325° C.-400° C. |
| 80000 | 8892 | 1.5 | 1.674 | 1.75% | Fail at 325° C.-400° C. |
| 100000 | 9204 | 1.6 | 1.683 | 1.68% | Fail at 325° C.-400° C. |

For the test data described in the above table, the polyimide composition as disclosed herein samples were fabricated into tensile bars according to ASTM E8—“Standard Tension Test Specimen for Powdered Metal Products—Flat Un-machined Tensile Test Bar” at room temperature and at pressures ranging from 20,000 to 100,000 psi. The tensile bars were sintered at 405 C with a nitrogen purge for 3 hours. Tensile strength and elongation were measured according to ASTM D638.

Specific Gravity was measured using Archimedes principle (ie. volume determined by measuring specimen weight in water and subtracting it from its dry weight. This volume is then divided into the dry weight to determine the specific gravity.)

Thermal Oxidative Stability (TOS) was tested by first immersing tensile bars or parts of tensile bars in alcohol for 15 minutes and drying at 300 F for 1 hr. Upon cooling, the specimens are weighed and then exposed to a temperature of 700 F for 100 hrs at a pressure of 70 psia in air. The final weight measurement is then taken and a percent weight loss of the tensile bars was calculated according to the following formula:

% Weight loss=(Initial wt.−Final wt./Initial wt)×100

Resistance to blistering during thermal exposure or rapid thermal cycling is tested by first immersing a tensile bar or part of a tensile bar in 95° C. water for 12 days. Next, the specimen is placed in a preheated oven at the specified temperature. A passing result is obtained when no visible cracking or blistering are present in the specimen after this thermal exposure. Samples compacted at 20,000 and 40,000 psi showed no visual defects after exposures up to and including 400° C. Samples compacted at 60,000-100,000 psi showed defects after exposure to temperatures of 325° C. and above.

It is noteworthy that the specimens compacted at 40,000 psi retained 88% of the Tensile Strength and 94% of the Elongation of specimens compacted at 100,000 psi while exhibiting positive blistering resistance performance at 400° C. vs. only 325° C. for the specimens compacted at higher pressures.

It should be noted that other methods can be employed to obtain low-density or increased pore density parts, such as the addition of sacrificial fillers that degrade or ablate or crush upon a thermal, chemical or mechanical processing step, resulting in a network of pores or pathways for moisture to egress. However, the method described herein is economic as additional fillers and processing steps are not required, while achieving a part with suitable mechanical integrity for high temperature application.

### Example 2

### Comparative Analyses

PROPERTY COMPARISONS
TRADITIONAL POLYIMIDE AND GRAPHITE VS
CO-POLYMER BASED POLYIMIDE

| | | | | Co-polymer |
|---|---|---|---|---|
| | | | | based |
| | | | Traditional | Polyimide of |
| | | Traditional | Carbon | the present |
| Property | Units | polyimide | graphite | in invention |
| Izod impact | J/m | 28 | 17 | 33 |
| (Notched heat | | | | |
| aged at 315° C. | | | | |
| Using ASTM | | | | |
| D-256 | | | | |
| Oil Absorption | % | 0.12 | 5.74 | 0.19 |
| | wt change | | | |
| Wear | % | 1.53 | 3.1 | 0.96 |
| (oscillating at | wt loss | | | |
| 315° C./25 hr) | | | | |
| Thermal | W/mK | 1 | 80 | 2 |
| Conductivity | | | | |

In “Example 2: Comparative Analyses”, the results in the column labeled “Traditional Polyimide” were obtained using a sample of 60 weight percent conventional polyimide and 40 weight percent graphite. “Traditional Carbon-graphite” results were obtained using graphite, free of polyimide. “Co-polymer based Polyimide of the present invention” results were obtained using a sample of 50 weight percent polyimide composition as disclosed herein and 50 weight percent graphite.

What is claimed is:

1. A method of making an article for high temperature application, said article comprising a co-polymer based polyimide composition, wherein said composition comprises
a) an aromatic tetracarboxylic dianhydride component; and
b) a diamine component further comprising;
(i) greater than 60 mole % to about 85 mole % p-phenylene diamine, and
(ii) 15 mole % to less than 40 mole % m-phenylene diamine;
wherein a) and b) are present in a ratio of 1:1; and
said method comprising:
forming a part of pre-determined shape using compression;
wherein the amount of pressure used in compression is from about 20,000 psi to about 50,000 psi to achieve a porous article having permeability to moisture, and resistant to defect caused by thermal exposure.

2. The method of claim 1 wherein said compression pressure is from about 35,000 psi to about 45,000 psi.

3. The method of claim 1 wherein said compression pressure is about 40,000 psi.

4. The method of claim 1 wherein said article has a higher cross-section area relative to the surface area of the article, and said article and is capable of releasing moisture and gas present in the cross-section area of the article through the surface area of the article.

5. A method of claim 1 wherein said polyimide composition comprises at least one filler or additive.

6. The method of claim 5 wherein said filler is carbonaceous filler, said carbonaceous filler being selected from the group consisting of natural graphite, synthetic graphite and carbon fiber.

7. The method of claim 6 wherein said filler is fluoropolymer and said fluoropolymer is selected from the group consisting of polytetrafluoroethylene.

8. The method of claim 5 wherein said filler is selected from the group consisting of kaolinite, sepiolite and mixtures thereof.

9. An article made by the method of claim 1.

10. The article according to claim 9 wherein said article is a component for hot glass handling.

11. The article according to claim 9 wherein said article is a take-out jaw insert or a take-out jaw assembly.

12. A method of using the article of claim 9, said method comprises using said article in a high temperature applications.

13. A method according to claim 12, said method further comprising replacing one or more graphite, metal, ceramic, or asbestos.

14. A method according to claim 12, said method comprising using said article as a component in glass manufacturing or glass container manufacturing.

15. An article of manufacture for use in a high temperature application, said article comprising a co-polymer based polyimide composition,
wherein said composition comprises
a) an aromatic tetracarboxylic dianhydride component; and
b) a diamine component further comprising;
i) greater than 60 mole % to about 85 mole % p-phenylene diamine, and
ii) 15 mole % to less than 40 mole % m-phenylene diamine;
wherein a) and b) are present in a ratio of 1:1; and
said article being porous and having permeability to moisture, and resistant to defect caused by thermal exposure.

16. The article of claim 15, said article being a mechanical handling component in the manufacture of glass containers.
